(19) United States
(12) Patent Application Publication
(10) Pub. No.: US 2020/0122691 A1
(43) Pub. Date: Apr. 23, 2020

(54) AUTONOMOUS CLEANING SYSTEM FOR A MOTOR VEHICLE

(71) Applicant: Continental Automotive GmbH, Hannover (DE)

(72) Inventors: Thomas Werner, Nentershausen (DE); Rolf-Dieter Schlein, Rotenburg a. d. Fulda (DE); Torsten Hahn, Homberg (DE); Heiko Kalthoff, Bad Rodach (DE); Tim Wagner, Darmstadt (DE)

(21) Appl. No.: 16/604,601

(22) PCT Filed: Apr. 5, 2018
(86) PCT No.: PCT/EP2018/058696

§ 371 Date: Nov. 26, 2019

(30) Foreign Application Priority Data
Apr. 13, 2017 (DE) 10 2017 206 469.2

(51) Int. Cl. B60S 1/48; B60S 1/50; B60S 1/52

(52) U.S. Cl. CPC B60S 1/481; B60S 1/56; B60S 1/52; B60S 1/50

(57) ABSTRACT

An electronically regulated cleaning system independently adjusted of the driver and adaptively to continuously variable operating conditions, for installation in a vehicle for cleaning at least one transparent element with a fluid cleaning agent, includes: at least one additive container storing additive for mixing with the cleaning agent, at least one electrically switchable metering device controlling mixing of the additive and cleaning agent, at least one electronic control unit adaptively controlling the electrically controllable components of the cleaning system, at least one cleaning agent filling level sensor monitoring the filling level of the cleaning agent and communicating with the electronic control unit, at least one freezing point sensor monitoring the mixture-dependent freezing point of the cleaning agent in the container and communicating with the electronic control unit, at least one surroundings temperature sensor monitoring the temperature of the surroundings outside the vehicle and communicating with the electronic control unit.

### CROSS REFERENCE TO RELATED APPLICATIONS

This application is the U.S. National Phase application of PCT International Application No. PCT/EP2018/058696, filed Apr. 5, 2018, which claims priority to German Patent Application No. 10 2017 206 469.2, filed Apr. 13, 2017, the contents of such applications being incorporated by reference herein.

### FIELD OF THE INVENTION

The invention relates to an autonomous cleaning system for a vehicle, for cleaning transparent elements of various purposes of use such as windshields, headlight lenses, and particularly optical components of optical or optoelectronic detection devices such as cameras, LiDARs, and comparable optical sensors, as well as a vehicle equipped with the cleaning system.

### BACKGROUND OF THE INVENTION

Most cleaning devices on the market are designed for cleaning windshields and rear windows, wherein a few further components can also be easily cleaned at the same time. Specialized cleaning devices are likewise known which are adapted specially for cleaning individual components such as, for example, headlight lens cleaning systems.

An important development trend with modern motor vehicles is autonomous, computer-controlled driving. This requires a wide range of assistance systems, which support the vehicle user when driving the vehicle and take over various functions. To do this, it is necessary to detect and monitor the environment of the vehicle automatically and reliably at all times. Some assistance systems are based on the information regarding the vehicle environment from optical or optoelectronic detection devices such as, for example, cameras, laser-based distance sensors (LiDARs), or infrared sensors. Such devices have transparent elements such as objective lenses or covers, which let light pass through without restriction or in a particular limited waveband depending on the application case. Because they are often arranged in the outer region of the vehicle, they are exposed to soiling and external weather influences and must be cleaned or deiced by a cleaning system as needed to ensure functionality.

With autonomous or partially autonomous driving, the detection devices must always be functional without driver intervention; this requirement inevitably also applies to the corresponding cleaning system, which likewise must always be operationally ready. This also relates to the supply quantity and sufficient frost-resistance of the cleaning agent.

With respect to the requirements developed from autonomous driving, the known cleaning systems have many disadvantages or are simply unsuitable. For example, the driver cannot evaluate the level of soiling of individual sensors or cameras alone because the driver essentially only has view of the windshield and possibly the rear window. However, if the cleaning needs of all components are controlled solely by the driver, it is possible that some consuming units, particularly in the rear area, will fail due to undetected stronger soiling.

The known cleaning systems are not or are only insufficiently expandable for cleaning, for example, a variable number of cameras and other consuming units depending on the vehicle and the configuration thereof and are thereby only complexly adaptable to specific customer wishes. If several components are wired together, some components will be unnecessarily cleaned as well even though it may not be explicitly necessary.

If the cleaning requirements of all components are adapted to the needs of the components most susceptible to soiling such as, for example, the rear camera, as a precaution, a disproportionately high consumption of cleaning agent will be the result, which is to be compensated only ineffectively by the supply of more quantities of cleaning agent and thereby reducing the usable volume.

If the cleaning agent freezes or is consumed early, for example due to unexpected weather events, particularly during the drive, the cleaning function will be unavailable, and the function of the cameras and sensors will be extremely vulnerable.

Other operation scenarios would place increased requirements on a reliable availability of the cleaning system such as, for example, with ride-sharing services where there are frequently and often very frequently changing drivers.

### SUMMARY OF THE INVENTION

Against this backdrop, an aspect of the invention is an especially effective cleaning system with reduced cleaning agent consumption, which is adjusted independently of the driver and adaptively to the continuously variable operating conditions and thus is especially well-suited for autonomous driving, in addition to offering effective, design expansion and adaption possibilities.

With the features according to independent claim 1, it is possible to design an intelligent, actively controlled, adaptive cleaning system, which can be integrated as an integrative component of the vehicle and which offers means, which ensure a predictive adaptation to changes in the operating conditions with utilization of the various information sources available in modern vehicles and responsive and trouble-free function of all optical detection devices under all weather conditions.

The individual cleaning needs of individual windows, cameras, sensors, and other consuming units can be determined individually, and the cleaning can take place economically optimized based on needs.

Due to the linking of the information in the control unit, reliable functioning of the cleaning system is available under the most varied of operating states. Due to the individual cleaning of each individual consuming unit, a greater number of cleaning cycles and longer operating period are enabled with the available supply of cleaning agent.

The cleaning system according to an aspect of the invention may implement primary pumps in connection with an individualized distribution system with additional pressure boost pumps and various electrically controllable components in order to optimally meet the special requirements of individual consuming units. For example, a high pressure can only be generated directly upstream of the outlet opening and thus the system inertia is reduced, and high-pressure lines are conserved.

Certain optical or optoelectronic detection devices capable of this can detect their level of soiling autonomously, for example through analysis of the light diffusion and/or light refraction on transparent components or the quantity of incident light and can transfer this to the electronic control device. In response, the cleaning of the particular consuming unit can be specifically initiated by the control device in that the corresponding pumps and/or valves are actuated.

In order to further reduce water consumption, there may be metering of the cleaning agent by means of volume-restriction devices. This can occur either through forced-metering devices programmed in the design, but also through switching valves or the time-discrete actuation of positive displacement pumps, for example gear pumps.

The system is completed by multilevel detection of the fluid levels of the cleaning fluid and of additives such as, for example, frost-protection or cleaning concentrate, as well as simultaneous detection of the frost resistance of the cleaning agent by a freezing point sensor. With falling temperatures, frost-protection concentrate can thus be automatically taken from a separate container and filled into the container of cleaning fluid in order to securely prevent freezing. Automatic flushing and/or consuming of the cleaning fluid in the lines can take place by means of an extraction device, for example as soon as the temperatures fall below the freezing point of the cleaning agent mixture in the line.

A further advantage of an intelligent cleaning system is that priorities are implemented with component cleaning when the fluid level in the cleaning agent container starts decreasing. Thus, it would be conceivable to switch off the cleaning-intensive rear camera when driving forward, to warn the driver, and to “reroute” the remaining fluid quantity to more important consuming units until refilling of the cleaning agent has occurred.

A further advantage is the calculation of the viscosity of the cleaning agent upon knowledge of the freezing point and the additive used. Thus, the pump actuation time can be adapted and extended in cold weather.

The cleaning agent container may be designed as a single container or as a double container, depending on need, for cleaning agent and additive or as a container with a cartridge option, wherein the additive can be supplied to the cleaning system as an easily exchangeable cartridge and/or interchangeable insert.

An aspect of the invention further relates to a vehicle in which the cleaning system according to an aspect of the invention is installed.

### BRIEF DESCRIPTION OF THE DRAWINGS

An aspect of the present invention is explained in more detail in the following by means of the exemplary embodiments shown in simplified form in the figures. The following is shown:

FIG. 1 a simplified schematic representation of an embodiment of the cleaning system according to an aspect of the invention;

FIG. 2 an exemplary embodiment of a consuming unit module;

FIG. 3 a greatly simplified schematic view of a further embodiment of the cleaning system according to an aspect of the invention, wherein the electronic control unit and electric connection lines are not shown;

FIG. 4 a greatly simplified schematic diagram of a system configuration of a possible embodiment of the cleaning system;

FIG. 5 a cleaning agent container and additive container combined in a common container housing according to an embodiment according to an aspect of the invention.

### DETAILED DESCRIPTION OF THE PREFERRED EMBODIMENTS

Elements which are the same or equivalent are given the same reference numbers in all figures, unless stated otherwise.

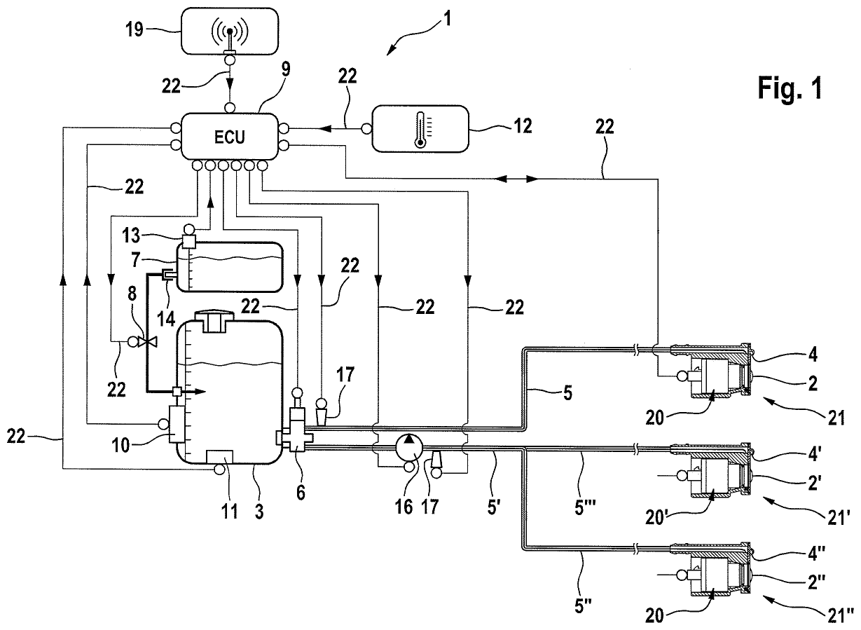

FIG. 1

FIG. 1 shows a greatly simplified embodiment of the electronically controlled cleaning system 1 according to an aspect of the invention. The cleaning system 1 is provided for installation in a vehicle and for cleaning one or more transparent elements 2 by means of one or more outlet openings 4. Particularly a component such as an objective lens or glass cover of an optical or optoelectronic detection device 20 such as, for example, a camera or a LiDAR, is suitable as the transparent element 2, wherein the viewing windows or headlight lenses are likewise reliable.

Cleaning takes place with a fluid cleaning agent, particularly a water mixture made of water and one or more additives such as frost-protection or cleaning-agent concentrate. The ready-to-use mixed cleaning agent is stored in the vehicle in a cleaning agent container 3.

An electrically controllable main pump 6, formed as a flow pump driven with an electric motor, conveys the cleaning agent from the cleaning agent container 3 through the hydraulic lines 5,-5′″ under pressure to the outlet openings 4, 4′, 4″, which spray the cleaning agent onto the transparent elements 2, 2′, 2″. An outlet opening 4 may be designed in any form within an aspect of the invention, for example as a borehole, a nozzle, a deflector, and the like.

An additive provided for mixing with the cleaning agent is stored in an additive container 7.

An electrically switchable metering device 8 is used for the controlled mixing of the additive with the cleaning agent.

Within an aspect of the invention, the metering device 8 may be formed, for example, as a switching valve, which can be switched between a closed and an open setting and, in the open setting, releases the hydraulic connection between the additive container 7 and the cleaning agent container 3.

The metering device 8 may likewise be formed as a positive displacement pump, which can be switched from a deactivated state into an activated state, wherein fluid cannot flow through it in the deactivated state and it conveys a defined quantity of additive per unit of time into the cleaning agent container in the activated state.

An electronic control unit 9 controls all electrically controllable components of the cleaning system 1 and is connected to the cleaning system via electric connecting lines 22.

A cleaning agent filling level sensor 10 and an additive filling level sensor 13 monitor the filling levels in the respective containers and transmit this to the electronic control unit 9.

With the assistance of a freezing point sensor 11, the mixture-dependent freezing point of the cleaning agent is measured in the cleaning agent container 3 and transmitted to the electronic control unit 9.

The ambient temperature outside of the vehicle is measured by an ambient temperature sensor 12 and likewise transmitted to the electronic control unit 9.

With the embodiment shown, the additive container 7 is formed as an interchangeable insert unit and/or an exchangeable cartridge, which is connected to the cleaning system 1 via a coupling interface 14.

Within an aspect of the invention, an exchangeable additive container 7 may also be arranged in a common housing with the cleaning agent container 3 such that the required coupling interface 14 would be arranged in or on the housing of the cleaning agent container 3.

An electrically controllable pressure boost pump 16 is arranged in the hydraulic line 5 between the main pump 6 and the outlet opening 4. This increases the pressure in the hydraulic line 5 locally between the pressure boost pump 16 and the outlet opening 4.

In the embodiment shown, electrically controllable extraction devices 17 are arranged directly behind the main pump 6 and/or pressure boost pump 16. They are used to extract the cleaning agent in the section of the hydraulic line between the extraction device 17 and the outlet opening 4 in order to prevent, for example, the freezing thereof and the associated clogging of the line 5.

Within an aspect of the invention, the extraction device 17 may be formed as an electrically switchable throttle valve, which, in its open setting, blows the cleaning agent out of the hydraulic line 5. In a similar manner, the extraction device 17 may be formed as an electrically controllable air inlet device, for example connected to a compressor, said air inlet device blowing air into the hydraulic line 5 as needed with overpressure and thus pushing the cleaning agent through the outlet opening 4.

A vehicle-integrated position-detection unit 19 such as, for example, a GPS sensor, transmits the current position of the vehicle to the electronic control unit. In conjunction with, for example, map data stored in the vehicle, the distance to the next service station, for example, can be calculated and a context-based warning generated when the filling levels in the containers 3, 7 are low. When the vehicle has a mobile Internet access, weather data, for example, can be accessed and, in conjunction with position information, frost-protection concentrate can be mixed with the cleaning agent as a precaution and the hydraulic lines extracted.

In the embodiment shown, the consuming units to be cleaned are shown as optical components of a detection device 20, which is positioned in a common housing with the outlet opening 4 and thus forms an easy-to-handle consuming-unit module 21.

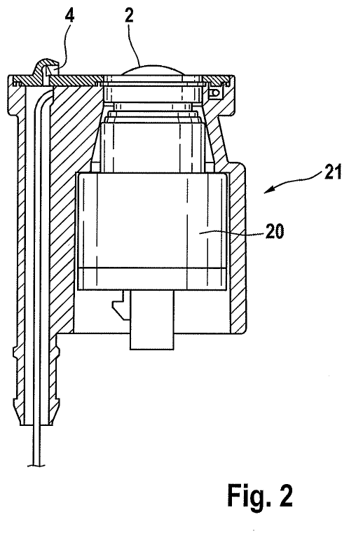

FIG. 2

Such a consuming-unit module 21 is shown by way of example in FIG. 2. The transparent element 2 to be cleaned is a component of an optical or optoelectronic detection device 20, for example the lens of a camera. The detection device 20 is suitable for two-way data and information transmission with the electronic control unit 9 and can thus detect its degree of soiling through relatively simple monitoring of the behavior of the light on the transparent element 2 and transmit this to the electronic control unit 9, which then calculates the quantity of cleaning agent necessary to specifically clean this same detection device and activates the necessary components for the calculated time.

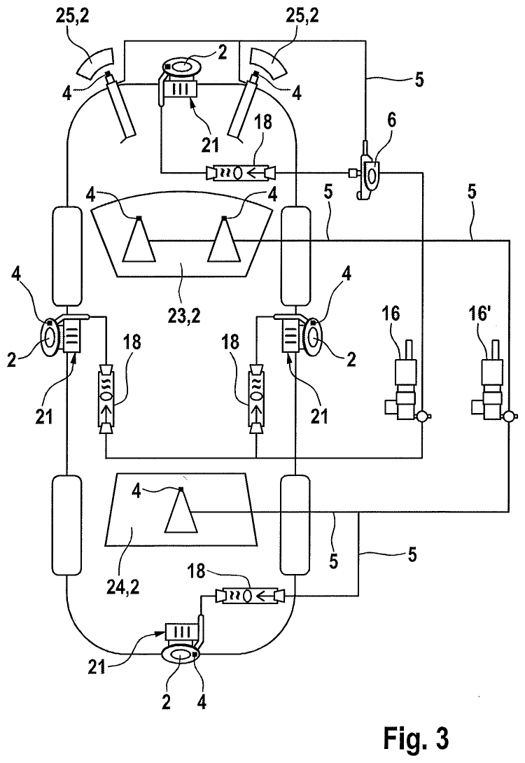

FIG. 3

In FIG. 3, the hydraulic portion of a further possible embodiment of the cleaning system 1 according to an aspect of the invention is shown in simplified form. In addition to the four consuming-unit modules 21, the windshield 23, the rear window 24, and the headlight lenses 25 are also cleaned in this case.

As a special feature with this embodiment, a volume-restriction device 18 is arranged at various points of the hydraulic line 5 between one of the pumps 6, 16 and the outlet openings 4. By means of this, the flow through the hydraulic line 5 can be interrupted in a defined manner according to a defined flowing fluid quantity in order to thereby implement, for example, short, intensive bursts of spray or to conserve the cleaning agent.

Within an aspect of the invention, the volume-restriction device 18 may be formed, for example, as an electrically switchable, particularly currentless closed valve, which, when activated by the control unit 9, releases the flow through the hydraulic line 5 only for brief intervals of time and otherwise blocks it.

In a similar manner, the volume-restriction device 18, as shown, may be formed as a forced-metering device with a pressure-controlled movable separating element, which forcibly blocks the hydraulic line 5 after the passing of a fluid quantity specified by design.

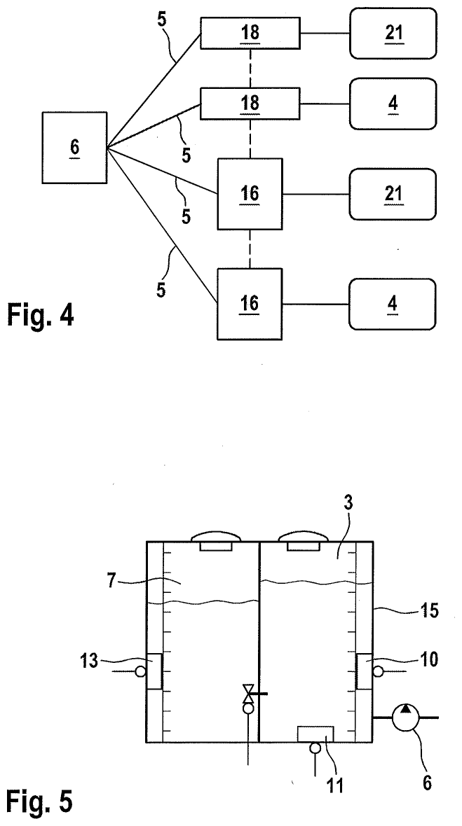

FIG. 4

In order to illustrate the adaptability of the cleaning system 1 according to an aspect of the invention, one of the many possible configurations is schematically shown here. Four hydraulic strands, each of which is configured differently, exit from a main pump 6. Thus, two of the strands each end with consuming-unit modules 21, wherein, with one of these strands, a volume-restriction device 18 is placed upstream of the consuming-unit module and, with the other strand, a pressure boost pump 16 is placed upstream. The other two strands, similarly one with the volume-restriction device 18 and the other with the pressure boost pump 16, end at simple outlet openings 4 in order to clean, for example, the windshield. However, each of these strands can be actuated individually with the cleaning system according to an aspect of the invention.

FIG. 5

FIG. 5 shows by example a further embodiment according to an aspect of the invention, in which the cleaning agent container 3 is formed as a cleaning agent chamber for the ready-to-use cleaning agent, and the additive container 7 is formed as an additive chamber which is inseparably formed in a common container housing 15.

### LIST OF REFERENCE NUMERALS

1 Cleaning system
2 Transparent element
3 Cleaning agent container
4 Outlet opening
5 Hydraulic line
6 Main pump
7 Additive container
8 Metering device
9 Electronic control unit
10 Cleaning agent filling level sensor
11 Freezing point sensor
12 Ambient temperature sensor
13 Additive filling level sensor
14 Coupling interface
15 Container housing
16 Pressure boost pump
17 Extraction device
18 Volume-restriction device
19 Position-detection unit
20 Optical or optoelectronic detection device
21 Consuming-unit module
22 Electrical connecting line
23 Windshield
24 Rear window
25 Headlight lens

1. An electronically controlled cleaning system for installation in a vehicle for cleaning at least one transparent element with a fluid cleaning agent, comprising:
at least one cleaning agent container for storing the cleaning agent;
at least one outlet opening for spraying the cleaning agent onto the transparent element;
at least one hydraulic line, which connects the cleaning agent container to the outlet opening;
at least one electrically controllable main pump for conveying the cleaning agent from the cleaning agent container into the hydraulic line;
at least one additive container for storing an additive provided for mixing with the cleaning agent;
at least one electrically switchable metering device for controlled mixing of the additive with the cleaning agent;
at least one electronic control unit, which adaptively controls the electrically controllable components of the cleaning system;
at least one cleaning agent filling level sensor, which monitors the filling level of the cleaning agent in the cleaning agent container and transmits this to the electronic control unit-;
at least one freezing point sensor, which monitors the mixture-dependent freezing point of the cleaning agent in the cleaning agent container and transmits the mixture-dependent freezing point to the electronic control unit; and
at least one ambient temperature sensor, which monitors ambient temperature outside of the vehicle and transmits the ambient temperature to the electronic control unit.

2. The cleaning system according to claim 1, wherein an additive filling level sensor is provided, which monitors a filling level of the additive in the additive container and transmits the filling level to the electronic control unit.

3. The cleaning system according to claim 1, wherein the additive container is formed as an interchangeable insert unit and/or an exchangeable cartridge, which can be connected to the cleaning system via a coupling interface and the refilling of which with the additive is not intended at all or at least not in the vehicle.

4. The cleaning system according to claim 1, wherein the cleaning agent container and additive container are formed inseparably in a common container housing.

5. The cleaning system according to claim 1, wherein the metering device is formed as a switching valve, which can be switched between a closed setting and an open setting and, in the open setting, releases the hydraulic connection between the additive container and the cleaning agent container.

6. The cleaning system according to claim 1, wherein the metering device is formed as a positive displacement pump, which can be switched from a deactivated state into an activated state, wherein fluid cannot flow through it in the deactivated state, and it conveys a defined quantity of additive per unit of time in the activated state.

7. The cleaning system according to claim 1, wherein at least one electrically controllable pressure boost pump is arranged in the hydraulic line between the main pump and the outlet opening, said pressure boost pump boosting a hydraulic pressure generated in the hydraulic line through the main pump in the direction of the outlet opening.

8. The cleaning system according to claim 1, wherein an electrically controllable extraction device is arranged on the hydraulic line, in the direction of the outlet opening, essentially directly behind the main pump or the pressure boost pump, for extracting cleaning agent contained in the hydraulic line between the extraction device and the outlet opening.

9. The cleaning system according to claim 8, wherein the extraction device is formed as an electrically switchable throttle valve, which can be switched between a closed and an open setting and, in the open setting, blows the cleaning agent out of the hydraulic line.

10. The cleaning system according to claim 1, wherein the extraction device is formed as an electrically controllable air inlet device, which can be switched from a deactivated state into an activated state, wherein it is closed in the deactivated state and it blows air into the hydraulic line with overpressure in the activated state.

11. The cleaning system according to claim 1, wherein a volume-restriction device is arranged in the hydraulic line between the main pump or the pressure boost pump, on one side, and the outlet opening, on the other side, said volume-restriction device interrupting the flow through the hydraulic line according to a defined flowing fluid quantity.

12. The cleaning system according to claim 11, wherein the volume-restriction device is formed as an electrically switchable valve, which can be switched between a closed and an open setting by the electronic control device and, in the closed setting, blocks the flow through the hydraulic line.

13. The cleaning system (1) according to claim 11, wherein the volume-restriction device (18) is formed as a forced-metering device, which forcibly blocks the hydraulic line (5) after the passing of a fluid quantity specified by design.

14. The cleaning system according to claim 1, wherein at least one position-detection unit is provided, which determines the current position of the vehicle and transmits the current position of the vehicle to the electronic control unit.

15. The cleaning system according to claim 1, wherein the vehicle has at least one mobile Internet access.

16. The cleaning system according to claim 1, wherein a frost-protection agent is contained in the additive.

17. The cleaning system according to claim 1, wherein a cleaning-agent concentrate is contained in the additive.

18. The cleaning system according to claim 1, wherein the at least one transparent element is a component of an optical or optoelectronic detection device, wherein the detection device is configured for two-way data transmission with the electronic control unit.

19. The cleaning system according to claim 18, wherein the detection device is formed to be capable of detecting a degree of soiling of the transparent element and transmitting this to the electronic control unit.

20. The cleaning system according to, claim 18, wherein the detection device along with at least one outlet opening are combined in a consuming-unit module.

21. The cleaning system according to claim 18, wherein at least four detection devices are installed in the vehicle and configured for cleaning by the cleaning system.

22. A vehicle in which a cleaning system is installed according to claim 1.
